(19) United States
(12) Patent Application Publication
(10) Pub. No.: US 2004/0040756 A1
(43) Pub. Date: Mar. 4, 2004

(54) Gyroscopically stabilized vehicle

(76) Inventor: Abdulareef Nmngani, Jeddah (SA)

Correspondence Address: BACON & THOMAS, PLLC, 625 SLATERS LANE, FOURTH FLOOR, ALEXANDRIA, VA, 22314

(21) Appl. No.: 10/232,515

(22) Filed: Sep. 3, 2002

(51) Int. Cl. B62D 6/00; B62D 11/02

(52) U.S. Cl. 180/6.2

(57) ABSTRACT

A gyroscopically stabilized vehicle includes a funnel-shaped member rotatable in a frame having a neck that supports two closely spaced generally parallel wheels and a relatively wide upper portion within or on which are located a motor for causing the stabilizer to rotate and for propelling the wheels, a support for a rider, and subsystems for controlling the rate of rotation of the stabilizer, steering the vehicle, braking the vehicle, and providing auxiliary stabilization when the rate of rotation of the stabilizer is decreased to permit rapid acceleration and high speed maneuverability. Power from the motor is transmitted directly to the funnel-shaped stabilizer member and to the wheels via a differential that distributes power between the stabilizer member and the wheels so that at low speeds, the stabilizer member is driven at a relatively high speed for maximum stability, and during acceleration, the rotation speed of the stabilizer is decreased in order to transmit maximum power to the wheels, with front-to-back stability being maintained during acceleration by independently controlled forward and rear auxiliary spoilers or stabilizers. Steering is facilitated by selective braking of the two wheels and, during high speed maneuvering, by selective braking of the stabilizer member and independent control of the auxiliary stabilizers and the position of the wheels relative to the frame.

### BACKGROUND OF THE INVENTION

1. Field of the Invention

The present invention relates to a motor-powered wheeled vehicle in which an upright orientation is maintained by a gyroscopic stabilizer member. The invention also relates to various braking, steering, aerodynamic control, and power transmission systems for use in a motor-powered wheeled vehicle of the type in which an upright orientation is maintained by a gyroscopic stabilizer member.

2. Description of Related Art

The use of wheeled vehicles for recreational purposes dates back at least to the days of ancient Roman chariot races. By harnessing a chariot to a team of horses, the chariot racer was able to experience a combination of speed and power that offered thrills unlike any other activity of the time. With the advent of gasoline powered engines, the amount of power available to recreational users increased significantly relative to cost, allowing a far greater number of persons to experience the adrenaline rush resulting from traveling overland at high speeds.

For many persons, a major part of the thrill of operating high speed motor powered wheeled vehicles results from the sense of danger involved in having the ground pass by at speeds which would cause serious injury if one were to fall from the vehicle. For such persons, motorcycles are superior to other types of recreational vehicles, such as sports or racing cars. Motorcycles offer an intimacy between rider and vehicle that is lacking in three or four wheeled vehicles such as sports cars. In a four wheeled vehicle, control of the vehicle requires sitting back while pushing pedals and turning a steering wheel. In contrast, the motorcycle rider embraces his or her vehicle, letting the vehicle respond to the most subtle movements, with the whole body being involved in its control.

The present invention seeks to provide a vehicle that offers pleasures similar to those provided by motorcycles, with an even greater degree of involvement by the rider in controlling the vehicle, and an even greater sense of danger provided by an apparent additional degree of freedom to crash, without making the vehicle unreasonably difficult to control or unduly increasing the actual risk of injury. To do this, the invention makes use of a gyroscopic stabilizer member, and in particular a rotating funnel-shaped member extending upwardly from a pair of closely spaced substantially parallel wheels.

According to the gyroscopic principle, when a symmetrical object is free to rotate about the axis of symmetry, any torques applied to a point on the object in a direction perpendicular to the axis of rotation will be added to the angular momentum of the point at which the torque is applied, diminishing the apparent effect of the torque and causing the axis of rotation to precess only slightly in response to the torque. This effect is readily seen in a child's top, and is also used as the basis for control systems in ships and aircraft, as well as in compasses and other orientation sensitive devices.

The type of gyroscopic stabilizer member utilized by the present invention is to be distinguished from flywheel-based arrangements, in which the stabilizer has a relatively high mass. The purpose of a flywheel is to store energy, and while the gyroscopic effect of a flywheel can be used to maintain stability, the mass of the flywheel increases the mass of the vehicle and makes acceleration, steering, and braking difficult. In contrast, the rate of rotation of the gyroscopic stabilizer member utilized by the vehicle of the present invention may be controlled in order to improve vehicle performance and handling.

A number of gyroscopically stabilized vehicles have previously been proposed, but each involves use of inertial flywheels having a large mass, the rate of rotation of which cannot be readily controlled, or unduly complex control and stability mechanisms. Examples of previously proposed vehicles of this type include those disclosed in U.S. Pat. Nos. 5,314,034 (Chittal), 5,181,740 (Horn), 3,876,025 (Green), 3,399,742 (Malick), 3,724,577 (Ferino), and 2,415,056 (Wheeler).

Unlike previous gyroscopically stabilized vehicles, the present invention does not rely solely on inertia, but rather drives the stabilizer only as necessary to maintain stability, with maximum power from the engine being available on demand to drive the wheels. The effect of the rotating cone is essentially transparent to the rider, with the stabilizer having little effect on performance and steering.

Even with the gyroscopic stabilization feature, a motor-powered vehicle with a wheel-base of zero would present stability problems due to the tendency of gyroscopic elements to precess when a force is applied. Pressing on the top of a spinning top will eventually cause the axis of the top to approach horizontal, and the same would be true of acceleration, deceleration, and steering forces. To counter these tendencies, the present invention adds aerodynamic stabilizers and scaled steering and braking controls which enable control of the vehicle to be maintained during high speed maneuvers. Despite these additional complications, however, the controls for the vehicle are simple hydraulic or mechanically actuated controls which should prevent the cost of the vehicle from exceeding the resources of the average thrill-seeking recreational user.

While the invention is particularly suited to manned operation, it will of course be appreciated that, as with other types of relatively stabile motor vehicles, such as automobiles and three wheeled recreational vehicles, remote control operation as a toy will also offer opportunities for fun and excitement. This aspect of the invention has no analogue in motorcycles, since balancing of a motorcycle can only be achieved by a rider.

### SUMMARY OF THE INVENTION

It is a first objective of the invention to provide a gyroscopically stabilized motor-powered vehicle which provides optimal performance and handling using relatively simple controls that can be manipulated by the average person.

It is a second objective of the invention to provide a gyroscopically stabilized motor-powered vehicle in which the wheels and stabilizer are driven by a common motor capable of delivering maximal on-demand power to the wheels for high acceleration, and in which the angular velocity of the stabilizer can be controlled in order to permit rapid acceleration and high speed maneuverability, with compensation for the reduced gyroscopic effect being provided by aerodynamic auxiliary stabilizers.

These objectives are achieved, in accordance with the broad principles of the invention, by providing a gyroscopically stabilized vehicle in which the gyroscopic stabilization member is a funnel-shaped member rotatable in a frame having a neck that supports at least one wheel and a relatively wide upper portion within or on which are located a motor for causing the stabilizer to rotate and for propelling the at least one wheel, a support for a rider, and subsystems for controlling the rate of rotation of the stabilizer, steering the vehicle, braking the vehicle, and providing auxiliary stabilization when the rate of rotation of the stabilizer is decreased to permit rapid acceleration and high speed maneuverability.

In a preferred embodiment of the invention, the vehicle includes a motor and two closely spaced generally parallel wheels, with power from the motor being transmitted directly to the funnel-shaped stabilizer member and to the wheels via a differential that distributes power between the stabilizer member and the wheels so that at low speeds, the stabilizer member is driven at a relatively high speed for maximum stability, and during acceleration, the rotation speed of the stabilizer is decreased in order to transmit maximum power to the wheels, with front-to-back stability being maintained during acceleration by independently controlled forward and rear auxiliary spoilers or stabilizers.

In an especially preferred embodiment of the invention, steering is facilitated by selective braking of the stabilizer member and the two wheels and, during high speed maneuvering, by the auxiliary stabilizers and by control of wheel position.

Preferably, the braking system including two types of brakes, one of which provides a fine braking control primarily for steering purposes and the other of which provides a higher degree of positive braking in order to decelerate the vehicle. The fine braking control is provided by a regenerative electromagnetic brake and the higher degree of positive braking is provided by a mechanical cam driven brake with anti-lock capabilities.

### BRIEF DESCRIPTION OF THE DRAWINGS

FIG. 1 is a perspective view of a gyroscopically stabilized vehicle constructed in accordance with the principles of a preferred embodiment of the invention.

FIG. 2 is a perspective view of the gyroscopic stabilizing member used in the gyroscopically stabilized vehicle of FIG. 1.

FIG. 3 is a perspective view showing details of a frame for the gyroscopically stabilized vehicle of FIG. 1.

FIG. 4 is a perspective view of a drive train used in the gyroscopically stabilized vehicle of FIG. 1.

FIGS. 5A-5C are perspective views showing the construction of a differential mechanism used in the gyroscopically stabilized vehicle of the preferred embodiment of the invention.

FIGS. 5D-5H are perspective views showing the construction of a second differential mechanism used in the gyroscopically stabilized vehicle of the preferred embodiment of the invention.

FIG. 6 is a perspective view of the overall steering and braking systems used by the gyroscopically stabilized vehicle of the preferred embodiment of the invention.

FIG. 7 is a perspective view of the principal braking mechanisms of the gyroscopically stabilized vehicle of the preferred embodiment of the invention.

FIG. 8 is a perspective view showing the two main braking subsystems used by the gyroscopic vehicle of the preferred embodiment of the invention.

FIG. 9 is a perspective view showing an electromagnetic braking subsystem used in the gyroscopic vehicle of the preferred embodiment of the invention.

FIGS. 10A-10D are perspective views of a mechanical braking subsystem for use in connection with gyroscopic vehicle of the preferred embodiment of the invention.

FIG. 11 is a perspective view of a controller that identifies the type of vehicle movement and direction of rotation for use in controlling the differential mechanism illustrated in FIGS. 5D-5H.

FIG. 12 is a perspective view of a steering control subsystem for use in connection with the vehicle of the preferred embodiment of the invention.

FIG. 13A is a perspective view of the operator steering controls used in the vehicle of the preferred embodiment of the invention.

FIG. 13B is a perspective view showing a portion of the power steering mechanism used in the vehicle of the preferred embodiment of the invention.

FIG. 14 is a perspective view of a braking mechanism for the gyroscopic stabilizer for the vehicle of the preferred embodiment of the invention.

FIG. 15 is a perspective view of an auxiliary stabilizer control system for use in connection with the vehicle of the preferred embodiment of the invention.

### DETAILED DESCRIPTION OF THE PREFERRED EMBODIMENTS

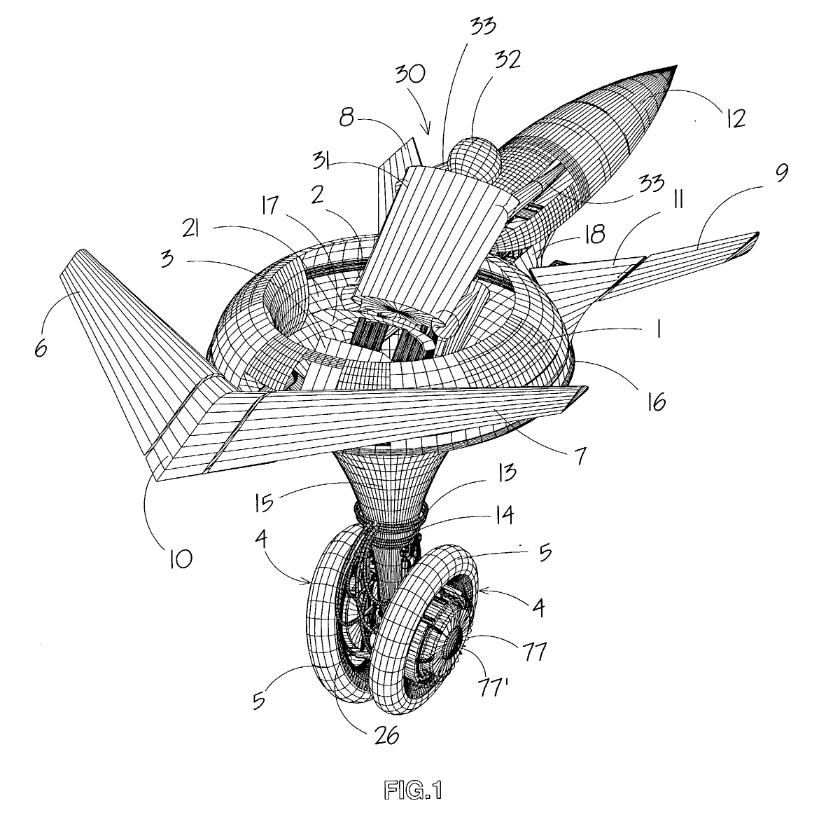

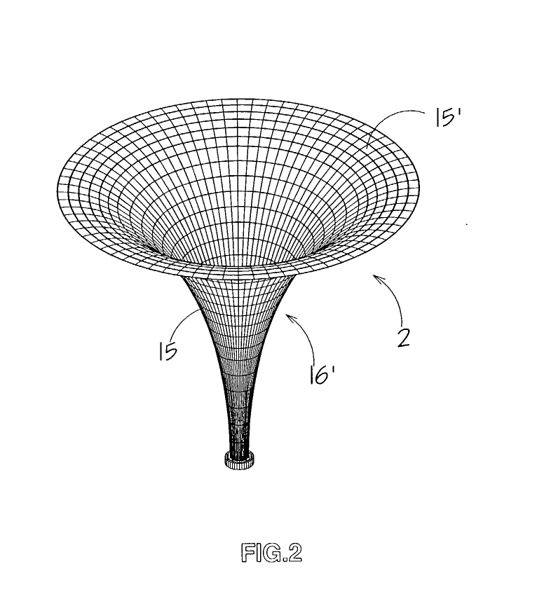

FIG. 1 is a perspective view of a gyroscopically stabilized motor-powered vehicle constructed in accordance with the principles of a preferred embodiment of the invention. The vehicle includes a generally funnel or inverted cone-shaped frame 1 in which is rotatably mounted a generally funnel or inverted cone-shaped gyroscopic stabilizer member 2, shown in detail in FIG. 2, and a motor 3. At the apex of the frame are mounted a pair of wheels 4 and tires 5. Extending laterally from the front and rear of frame 1 are auxiliary stabilizers 6-9, each of which is independently movable relative to one of respective supports 10 and 11, while a control pod 12 extends forwardly of the cone-shaped frame 1. Also shown in FIG. 1 are braking control lines 13 for controlling a magnetic and mechanical braking system used for both deceleration and steering purposes, and additional steering control lines 14 used to control wheel positions during high speed maneuvering.

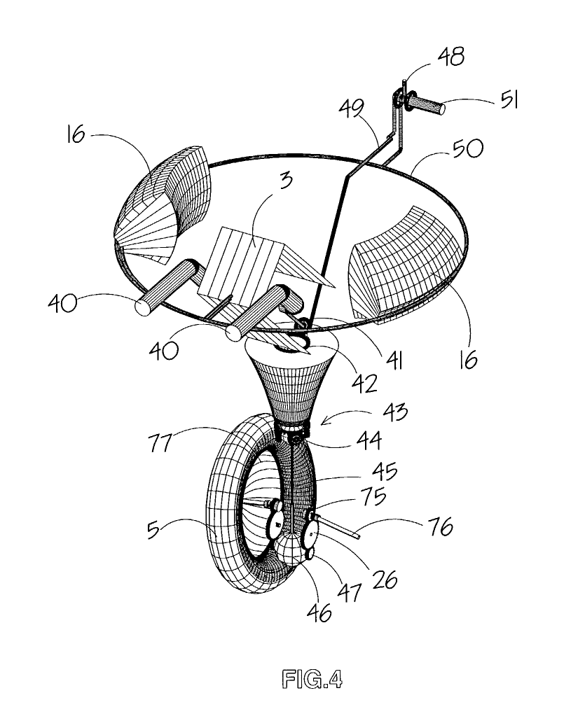

As is apparent from FIG. 2, the stabilizer member is generally in the form of a funnel 16′ having a relatively long cylindrical base portion 15 and a wide upper portion 15′ which can be fitted into a correspondingly-shaped base and upper portions of the frame on appropriate bearings. If the facing surfaces of stabilizer and frame are sufficiently smooth, for example, a Bernoulli effect can be utilized to permit the stabilizer to “float” relative to the frame, i.e., to be pneumatically supported, eliminating the need for mechanical bearings, although mechanical bearings may also be used. The width of the upper portion of the frame must be sufficient to permit a seat 17 to be mounted in the frame, and to leave room for the rider's legs to extend downwardly. In addition to the seat, the frame contains the motor 3, and a foot-actuator for the main braking mechanism. There is also a gear 16″ (not shown in FIG. 2, but shown in FIG. 4) mounted in the inner surface of the portion 15. This gear touches the four gears 44 which are connected to the propulsion system that provides power for rotation of the cone. The remaining controls can be placed on the outside of the frame or in control pod 12.

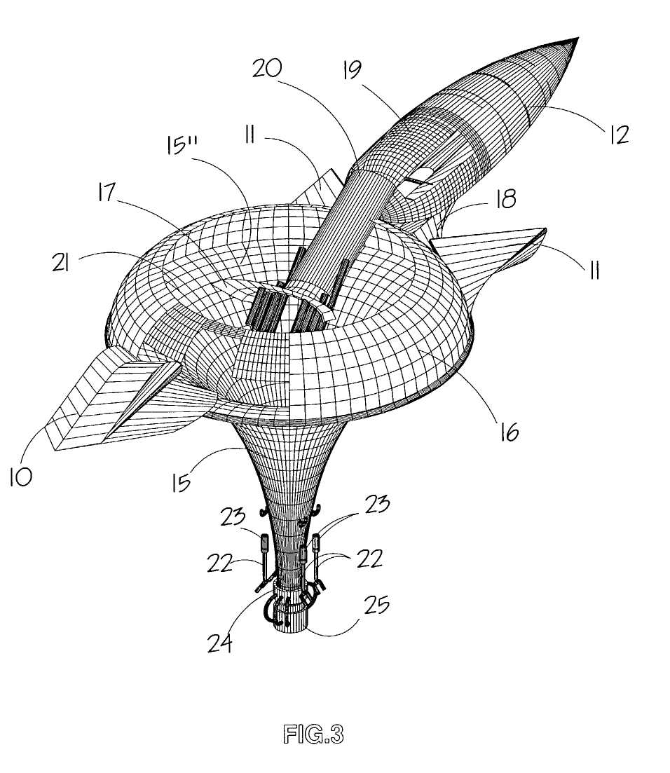

Control pod 12 can be designed to have an aerodynamic shape, or simply to serve as a windbreak for the rider, and includes as best shown in FIG. 3 a handlebar support 19 and torso support 20 against which the rider can lean while controlling the vehicle. Preferably, the frame includes interior surfaces 21 that cover at least portions of the rotating gyroscopic stabilizer member 2 to protect the rider from contact with the stabilizer. In addition, as also shown in FIG. 3, frame 1 supports a set of struts 22 and cylinders 23 connected to control lines 14 for changing the position of the wheels, i.e., banking the vehicle, in response to a steering command, and support rings 24 and 25 which support drive gears 26 and 26′ for the wheels. The wheels are supported on axles (see FIG. 4) by hubs 77′ and spokes 77.

It will be appreciated by those skilled in the art that while the vehicle of the preferred embodiment includes wheels 4 having tires 5, the principles of the invention are not limited to two-wheeled vehicles, but rather may be extended to cover vehicles having multiple wheels and tracks designed to travel in snow or mud, as well as, in its broadest form, to vehicles with only one wheel, and to vehicles having auxiliary wheels in varying numbers, skis, or other stabilizing or traction elements. In addition, while FIG. 1 shows a person 30 having a body 31, head 32, and arms 33 seated in the vehicle on seat 17, the vehicle could also be designed to be operated by remote control in an unmanned condition, for example for use as a toy or novelty item, with the rider replaced by an infrared or radio frequency receiver and electromagnetic actuators for the various subsystems.

Because of the high center of balance of the vehicle relative to its wheelbase, it may be necessary to provide some sort of supporting mechanism (not shown) in order to hold the vehicle in an upright position before starting the motor. However, once stabilizer 2 has reached a sufficient rotational speed, the vehicle will maintain an upright position without added support even while the rider is climbing into the vehicle. Access to the vehicle can be facilitated by including doors in the portion of the frame which extends above the top of the rotating stabilizer, although the height of the vehicle may be low enough so that the rider could simply step over the top of the frame in order to enter the vehicle.

As shown in FIG. 4, motor 3, illustrated as an internal combustion powered engine with exhaust pipes 40, but which could also be an electrically-powered or hybrid internal combustion/electric motor, outputs power to a gear 41 which transmits power to a gear 42 coupled by a shaft (not shown) to a differential mechanism 43 through a transmission system. Differential mechanism 43 transfers power to output gears 44, which are connected to cone gear 16″ and shaft 45, respectively, in order to drive gyroscopic stabilizing member 2 and wheels 4. Shaft 45 serves as an input to a second differential mechanism 46, which transfers power to two output gears 47 arranged to drive gears 26 shown in FIG. 4.

A lever 48 mounted on right stationary handlebar 51 is connected by wires to the clutch mechanism, with the wires being carried in conduit 49, while a second conduit 50 extending around the periphery of frame 1 from handlebar control 51 carries engine speed signals in a manner similar to corresponding motorcycle speed controls.

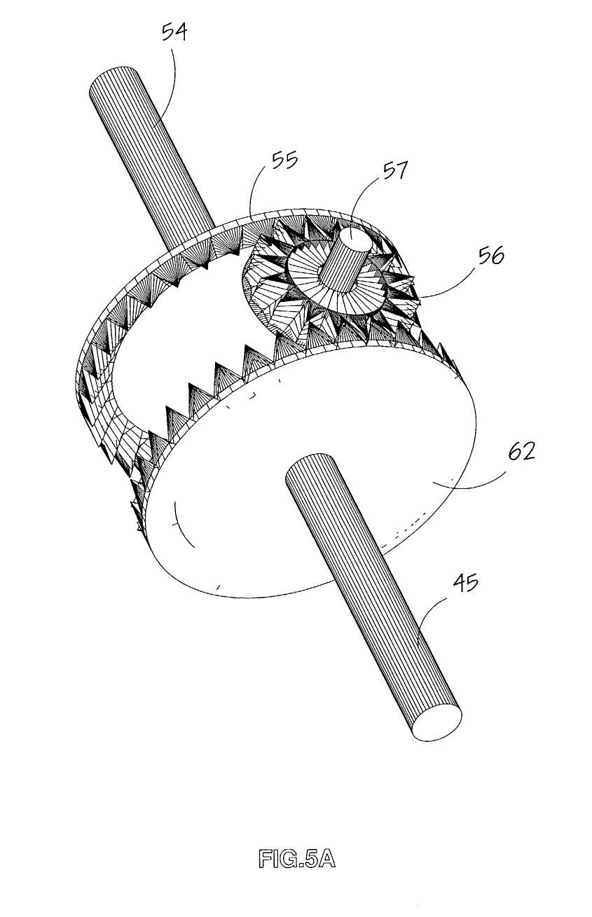

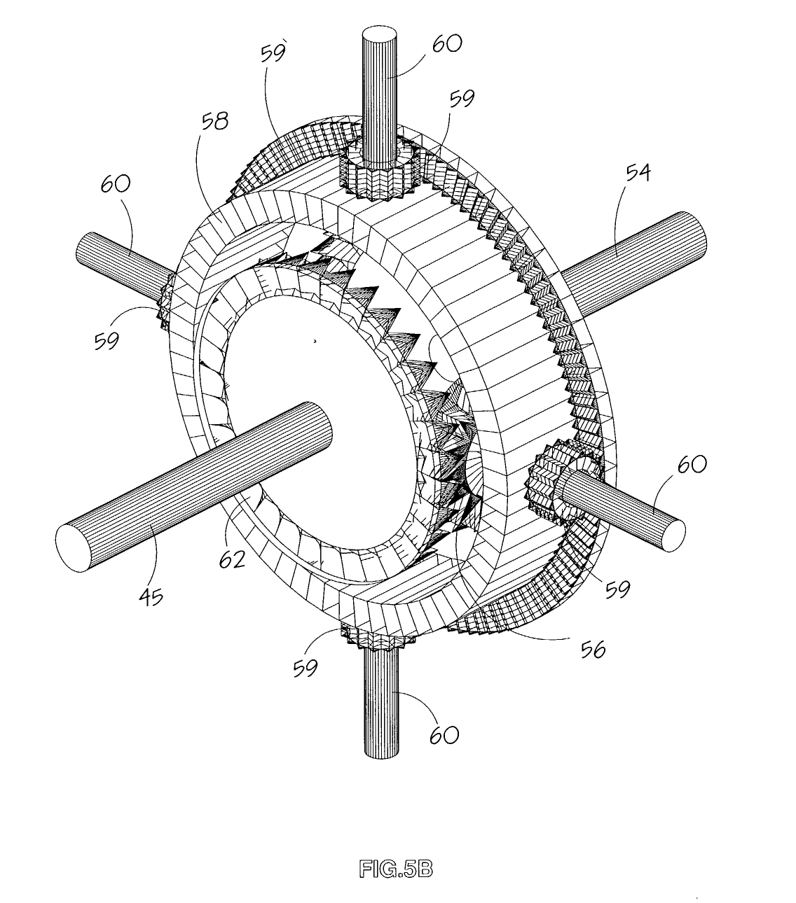

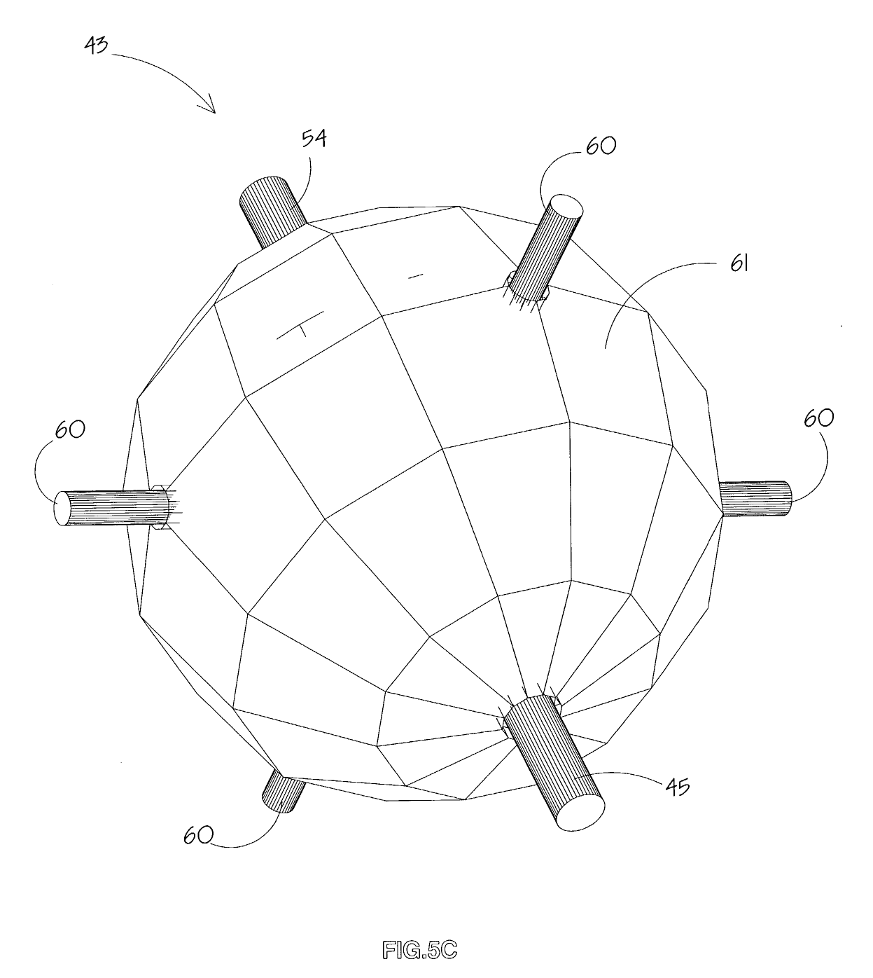

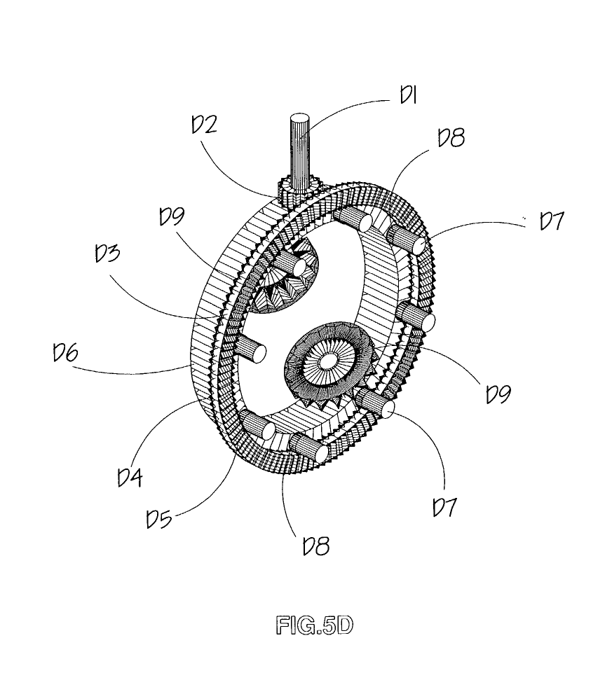

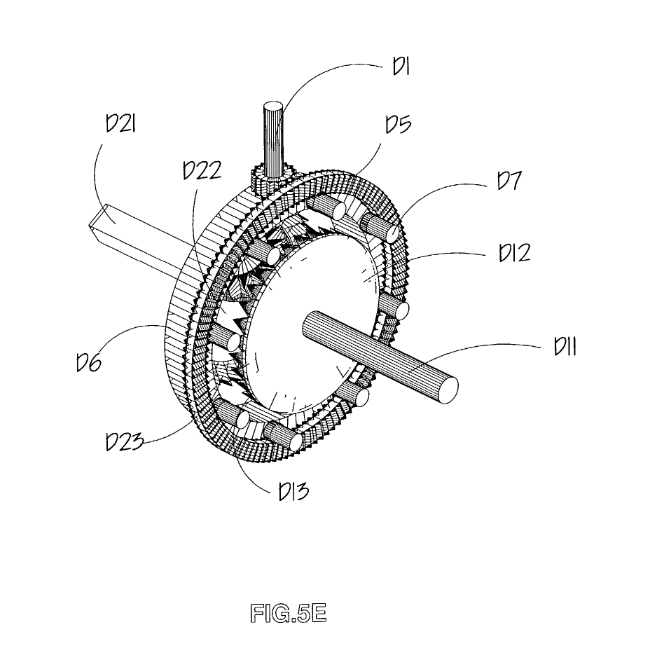

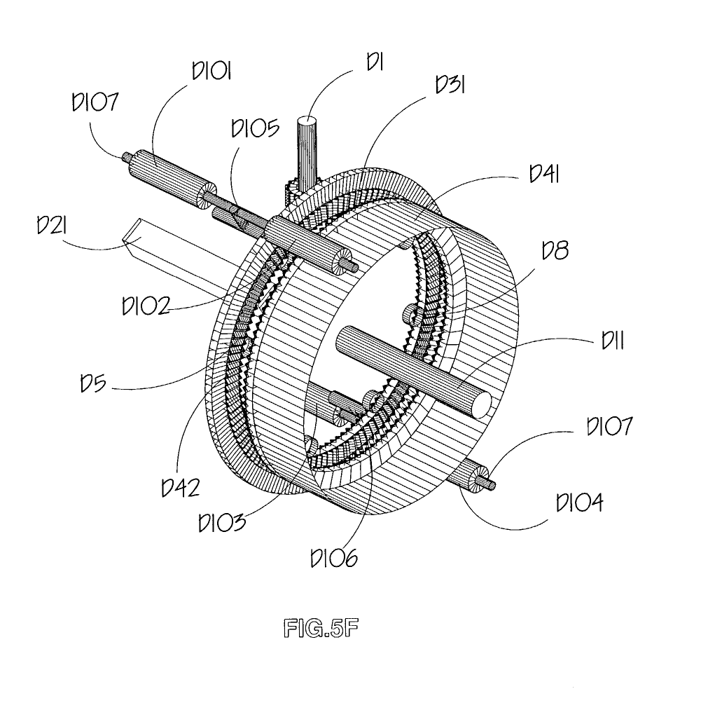

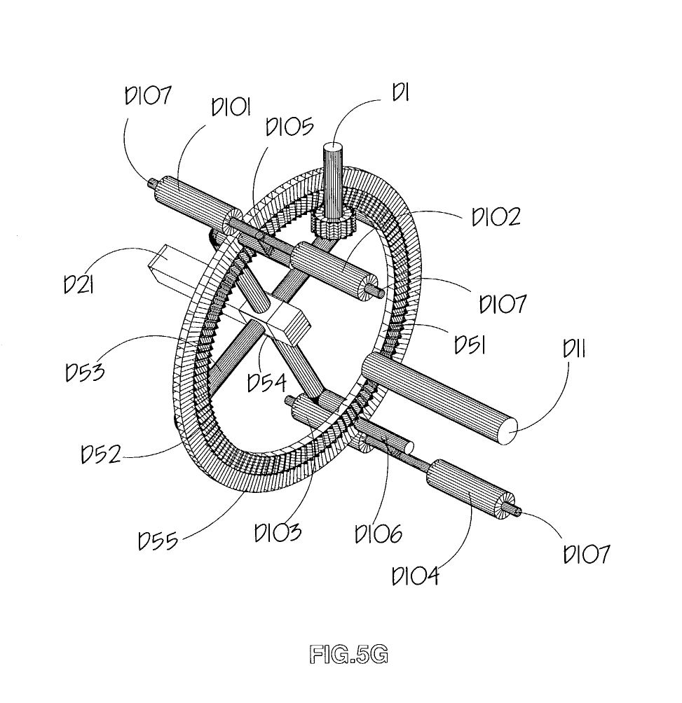

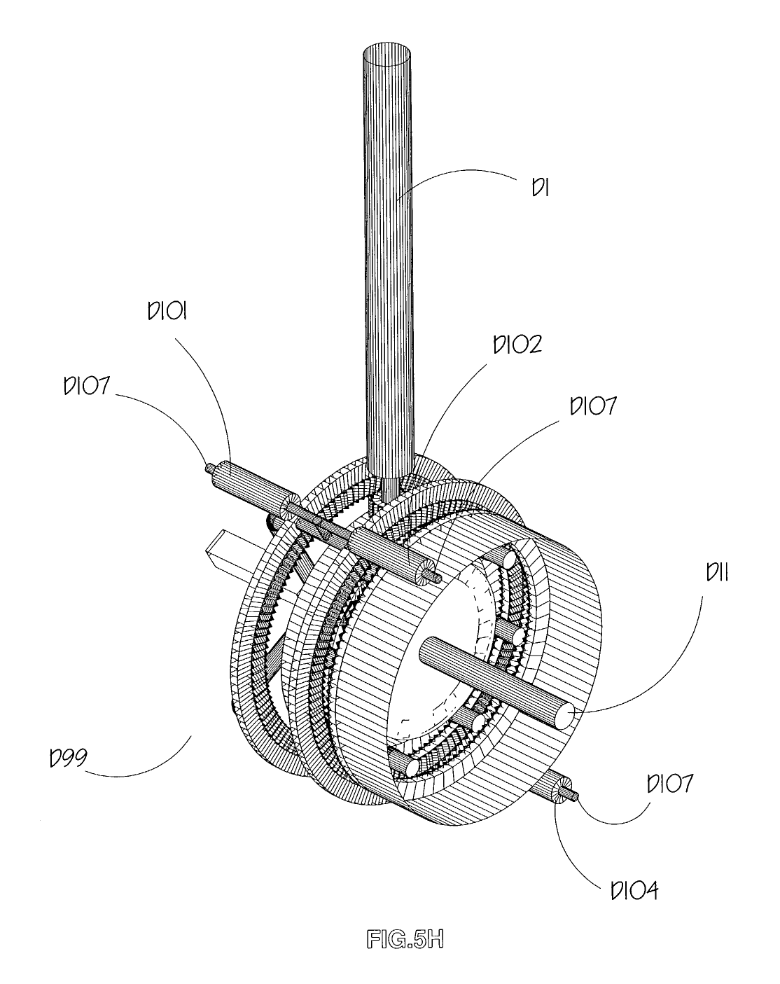

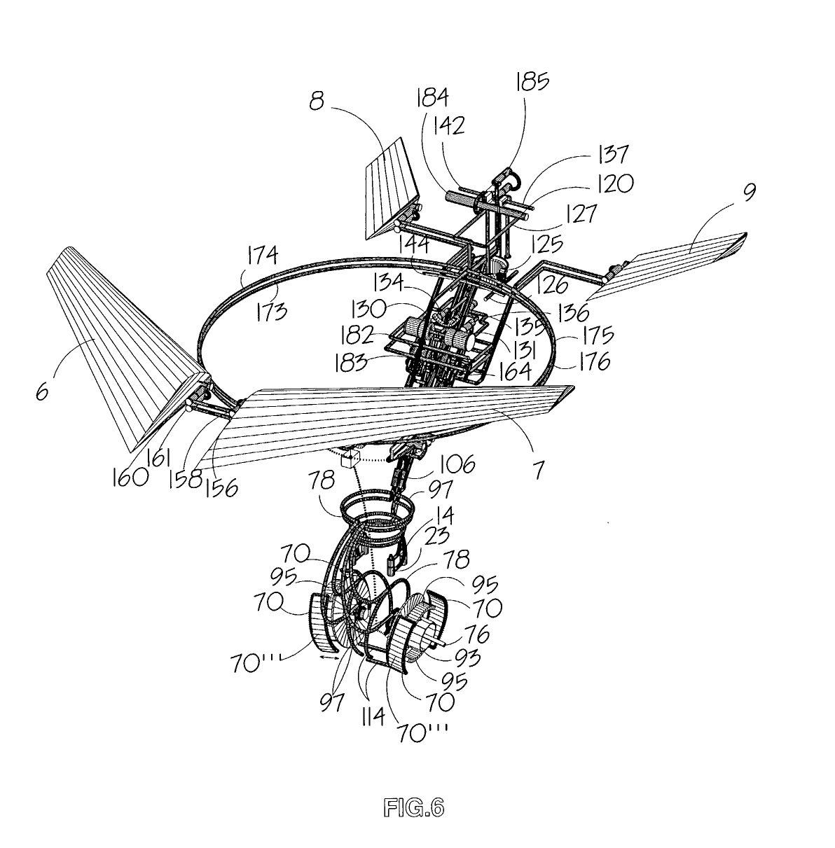

The operation of differential 43 is illustrated in FIGS. 5A-5C. Input power to the differential is provided by shaft 54 and bevel gear 55, which engages bevel gears 56. Each of bevel gears 56 is connected to a shaft 57 situated inside a cylindrical member 58. There is a gear 59′ fixed in the member 58, which drives a number of other gears 59. Gears 59 are connected to shafts 60 which extend outwardly through openings in the differential housing 61 and which are attached to gyroscopic stabilizer 2 through the gears 44, gears 44 being connected to gears 59 through output shaft 60. In addition, bevel gears 56 also engage a second bevel gear 62 connected to output shaft 45 through the gears 44.

In operation, rotation of shaft 54 and bevel gear 55 causes rotation of bevel gears 56. If second bevel gear 62 is prevented from rotating because the wheels are braked, then gears 56 will orbit around the input axis, causing the member 58 to rotate and eventually the gear 59′ to rotate, thereby transmitting power to gears 59 and shafts 60 connected to gears 44, causing the gyroscopic stabilizer member to rotate. On the other hand, if the gyroscopic stabilizer member is braked or prevented from rotating, then rotation of gears 56 causes gear 62 and shaft 45 to rotate, transmitting power to the wheels, with the amount of power distributed between the stabilizing member and the wheels proportionally to the relative braking forces applied to the stabilizing member and wheels. As a result, differential mechanism 43 automatically distributes power between the stabilizing member 2 and the wheels 4.

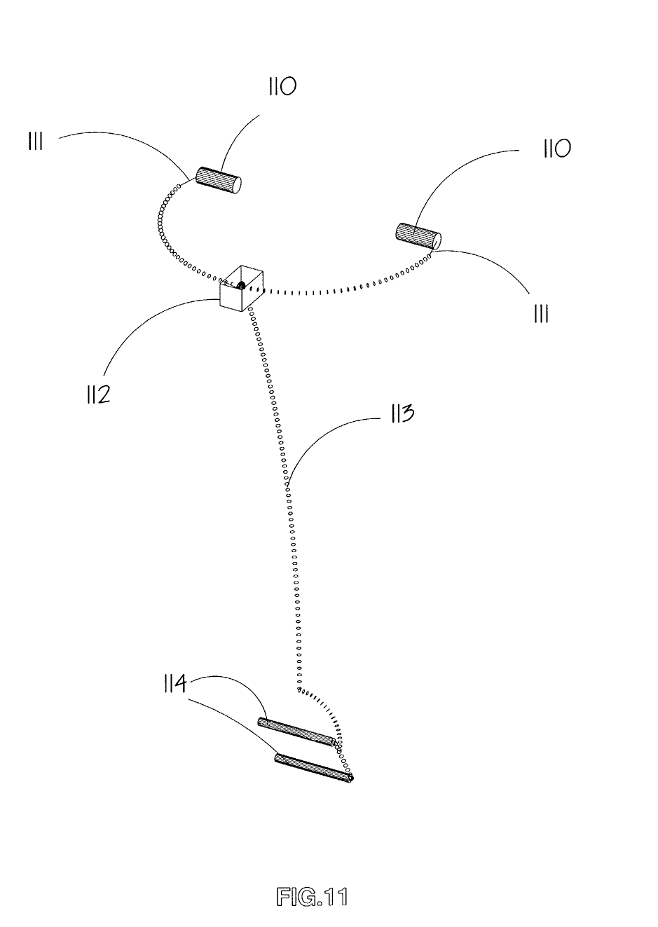

The second differential mechanism 46 is a regular differential that has some modifications, as illustrated in detail in FIGS. 5D to 5G. FIG. 5H shows the relationships between the various elements illustrated in FIGS. 5D-5G. A driver for the second differential is illustrated in FIG. 11, described below.

The primary components of the second differential mechanism are illustrated in FIG. 5D, and include a primary gear D2 attached to the propulsion source through a rod D1 (D1 here is shaft 45), and gear teeth D4. Rods D7 are fixed to one of the sides of driving ring D6, and driving gears D9 are situated inside the ring. In addition, the second differential mechanism includes a ring D3 connected to ring D6 and having teeth D4 on an inner side and teeth D5 on an outer side. Inside ring D3 are smaller rings D8 that touch rods D7.

FIG. 5E shows the terminal gears in the differential mechanism of FIG. 5D. These include a right gear that consists of a rod D11, teeth D13, and base D12, and a left gear that consists of a rod D21 having a square shape, teeth D23 and base D22. The terminal gears engage the driving gears D9 from one side and the gears 47 from the other side, in the manner of a conventional differential. Unlike the conventional differential, however, the differential of the preferred embodiment further includes a freely rotatable member D31 attached to the ring D3, and H-shaped members D105 and D106 that engage member D31. These H-shaped members are also connected to actuators D101, D102, D103, and D104 which are connected through a wire with the controlling pedals. A fixing member D41 is fixed to the differential mechanism from one of its sides, and has teeth D42 at the other side, as shown in FIG. 5F.

Finally, as illustrated in FIG. 5G, the left terminal gears are driven by ring D51 having teeth D52 on a first side, and connections to L-shaped rods D53 on a second side. The four L-shaped rods are fixed to a square sleeve D54 that slidably holds a rod D21. Like the ring D3, ring D51 is attached to a freely rotatable member D55, which is further attached to the H-shaped members D105 and D106.

Operation of the differential illustrated in FIGS. 5D-5H is similar to that of an ordinary differential. Rotation of gear D2 causes ring D3, which drives rods D7 and small rings D8, causing rotation of ring D6. Rotation of ring D6 in turn causes rotation of driving gears D9, which drives the wheels of the vehicle through the left and right terminal gears.

The differential is engaged by pulling the pedals 110 in order to pull a wire 113, as illustrated in FIG. 11, described below. Wire 113 activates the actuators D101, D102, D103, and D104. These actuators move the H-shaped members D105 and D106, which move the freely rotatable member D31, ring D3, and teeth D4 away from the primary gear D2. Movement of ring D3 also engages teeth D5 with teeth D42 to lock the ring D3 and driving gear D6. The movement of the H-shaped members also moves the freely rotatable member D55 closer to the primary gear, which consequently moves the ring D51 and teeth D52 in order to touch the primary gear D2. Rotation of the primary gear D2 that engages teeth D52 rotates ring D51, which rotates rods D53 and D21. Rod D21 is connected to the left wheel and therefor will rotate the wheel. Moreover, rod D21 is connected to the base D22 and teeth D23, which are connected to the driving gears D9. Therefore, rotation of rod D21 causes rotation of the driving gears D9 because the driving ring D6 is locked. Rotation of the driving gears then causes rotation of the teeth D13, the base D12, and consequently rod D11 which is connected to the right wheel in a direction opposite to the direction of the left wheel.

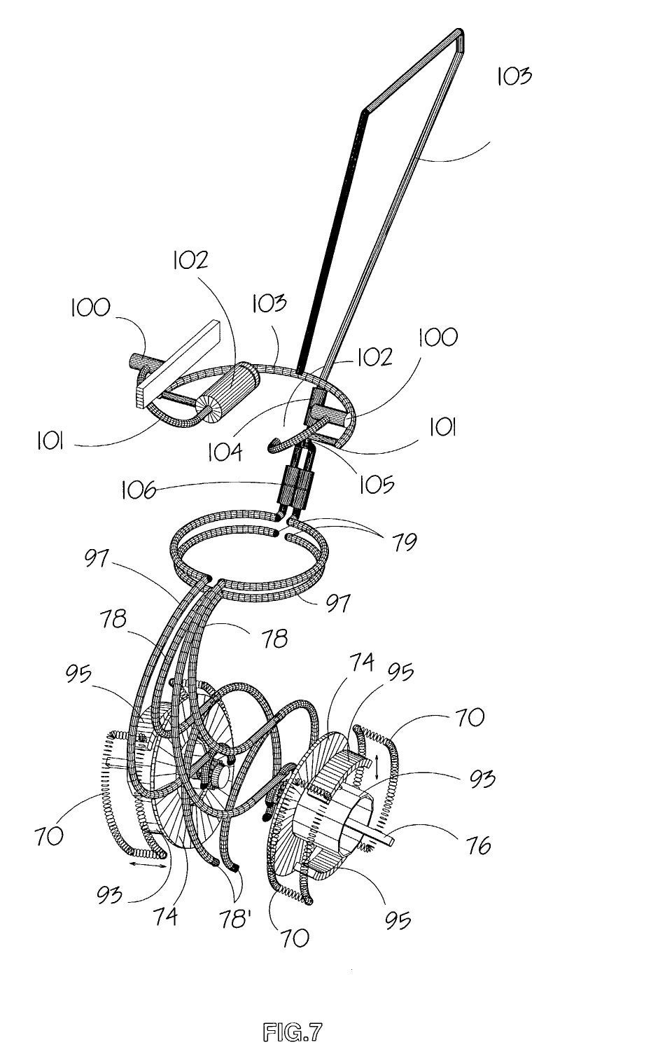

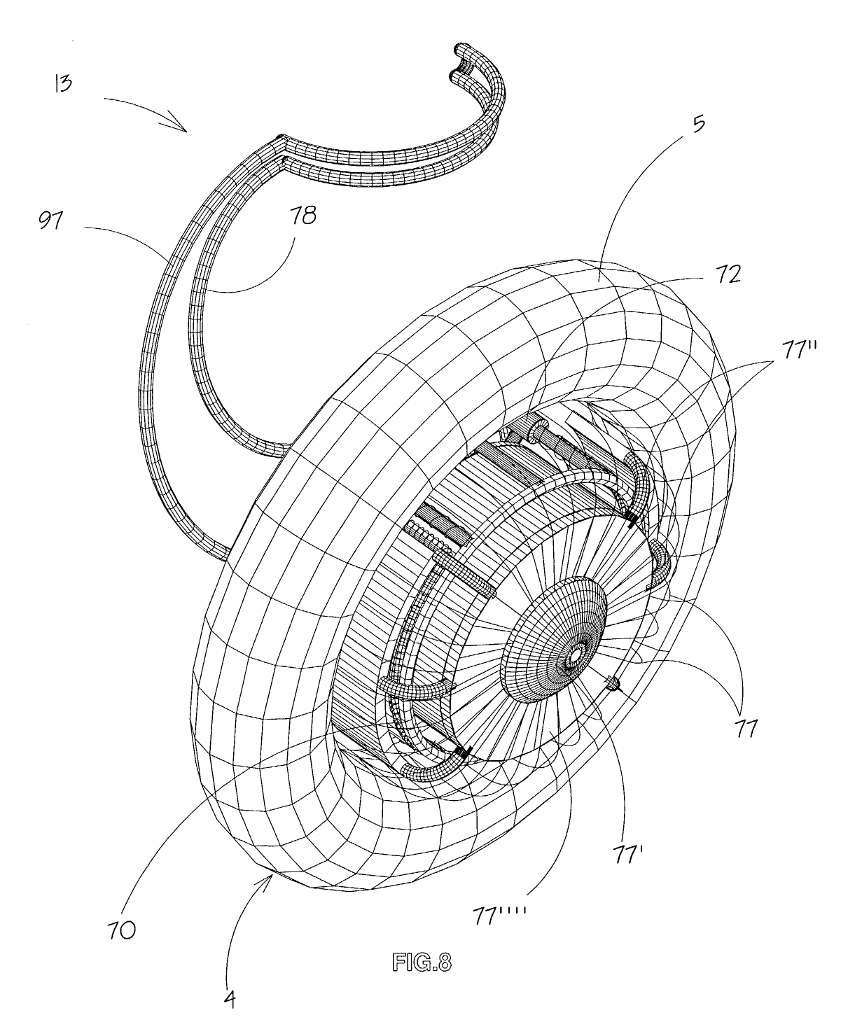

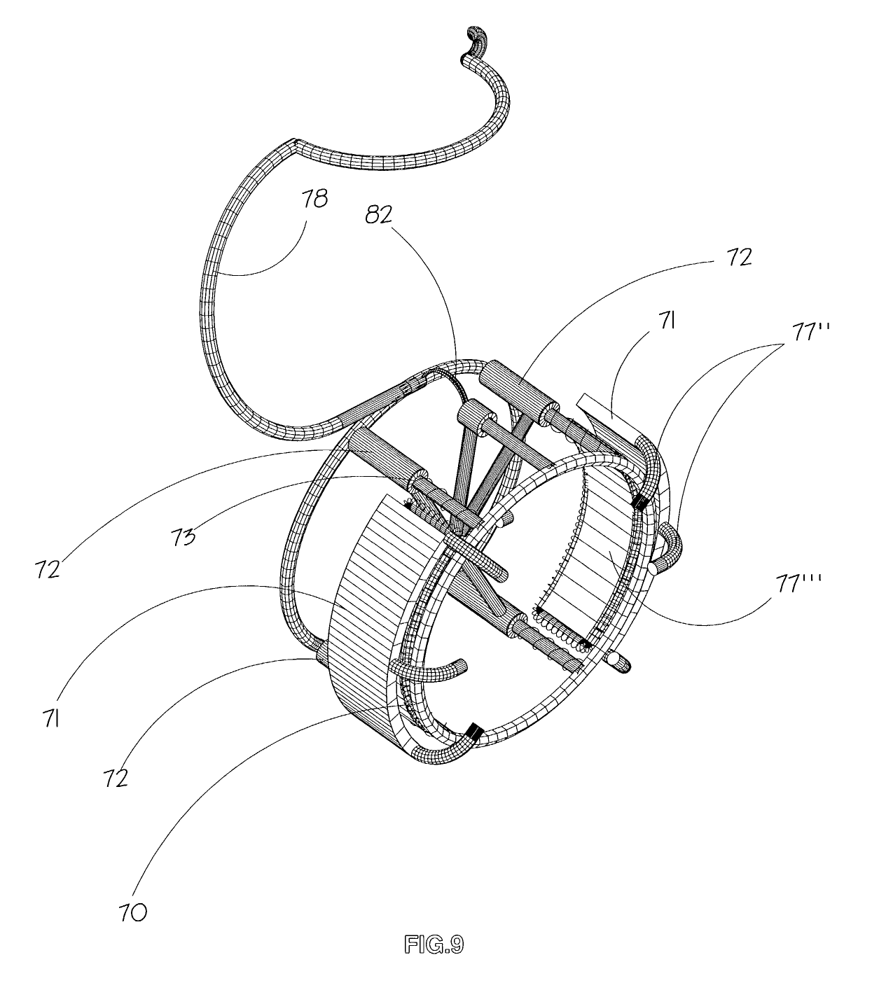

The gyroscopically stabilized vehicle of the preferred embodiment of the invention utilizes two principal braking systems. The first is a magnetic braking mechanism that provides fine control for purposes of steering the vehicle, and the second is a mechanical brake that provides a greater braking force and is used to decelerate the vehicle. In addition, a parking brake for the cone is provided to lock the wheels during initial start-up so that full power can be transmitted by differential mechanism 43 to the cone-shaped gyroscopic stabilizer 2. The magnetic braking system is illustrated in FIGS. 7-9, while the principal mechanical brake is illustrated in FIGS. 7, 8, and 10A-10D. Both braking systems are connected together, i.e., pressing the brake pedal activates both of them. However, the magnetic braking mechanism is softer than the mechanical braking mechanism and therefore will be activated first, the mechanical braking system being activated upon further pressing of the braking pedal.

The magnetic braking mechanism utilizes the drag exerted by pairs of coils 70 wrapped around a magnetizable element 70′″. The composite member, i.e., coils 70 and 70′″ are situated in a magnetic field generated by pairs of magnets 71 mounted in or on each of the wheels 4 to rotate with the wheels around the coils 70. The transfer of energy from the moving wheels, and therefore from the rotating magnets 71, to the coils is accomplished by the induction effect, in which the relative movement of the coils and the magnetic field surrounding the magnets causes a current to be induced in the coils. The number of turns of the coils that are within the magnetic field of the magnets determines the amount of rotational energy transferred to the coils according to well-known principles of electromagnetic energy transfer, with the transfer of rotational energy resulting in a rotation retarding force being exerted by the coils on the wheels. By moving the coils into and out of a position between the magnets for each of the wheels, the amount of energy transferred can be precisely controlled.

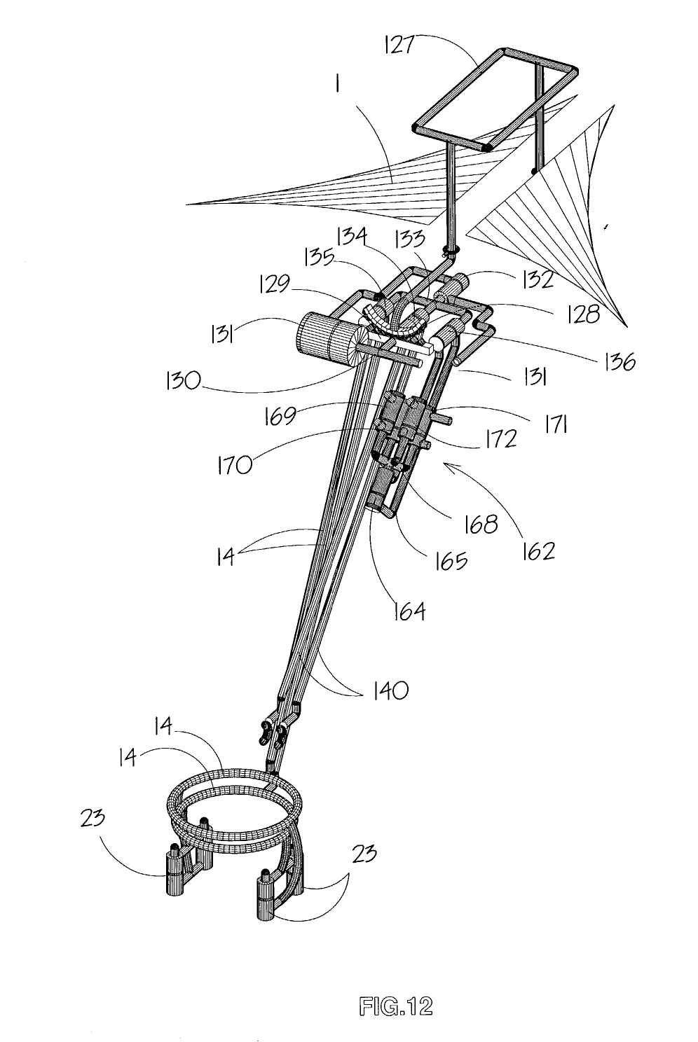

Movement of the coils with respect to each of the wheels 4 is accomplished by four hydraulic actuators 72 having pistons 73 arranged to move the coils into and out of a space present between the inside surface of wheels 4 and a non-rotating disc 74. Disc 74 supports the non-rotating portions of the braking mechanism and is connected to frame 1 by struts 22, while power to the wheels is supplied by gear 75. Gear 75 is driven by gear 26 and is pivotally connected to axle 76, and axle 76 is connected to the magnet 71 by spokes 77″ and to the corresponding wheel 4 by cover 77″″ and spokes 77 located on the outside of the wheel assembly so as not to interfere with movement of coils parallel to the axle. Each of the actuators 72 is connected to branches 78′ of a common hydraulic fluid line 78, which in turn is connected at ends 79 to steering control lines 140 and magnetic brake master cylinder 134, shown in FIG. 12. One fluid line 78 controls the left side pair of coils and the other controls the right side pair.

Those skilled in the art will appreciate that in order to complete the transfer of energy from the wheels to the magnetic braking system, the current induced in the coils must dissipated, which can be accomplished by supplying the current to a battery or to other electrical subsystems via wires 82. In addition, those skilled in the art will appreciate that while the actuators for moving the coils in appreciate that while the actuators for moving the coils in and out are hydraulic, as will be explained below, the invention could also be implemented using mechanical or electro-mechanical actuators.

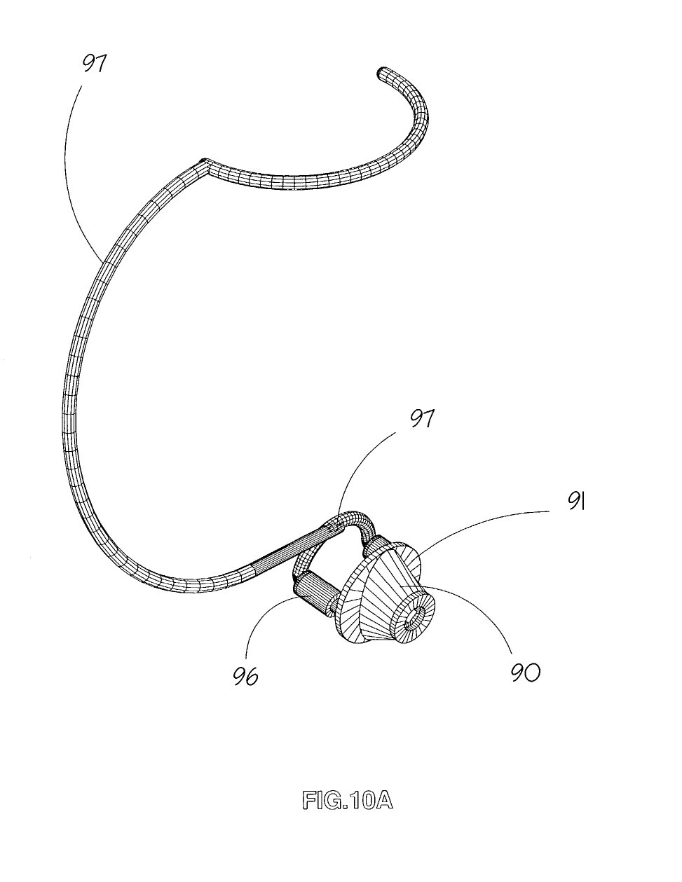

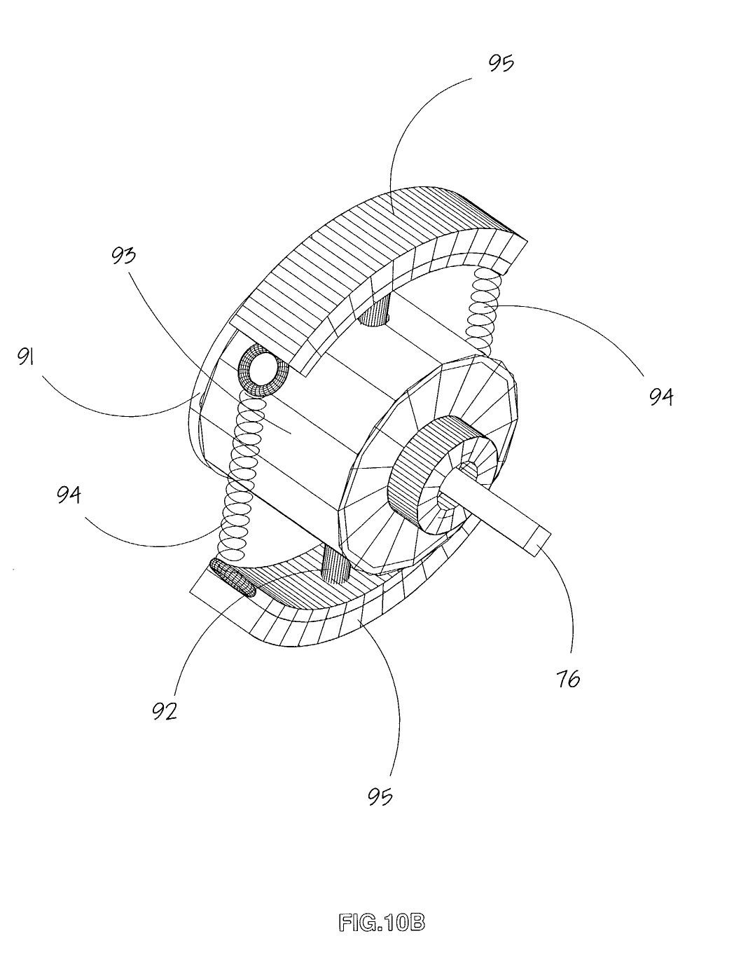

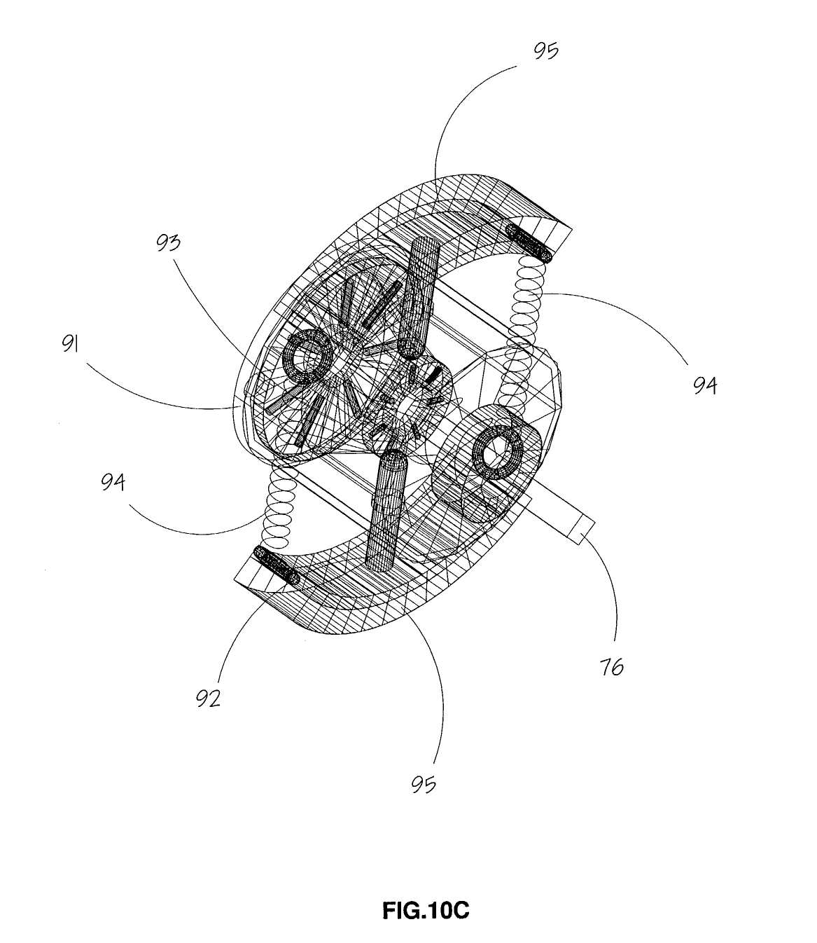

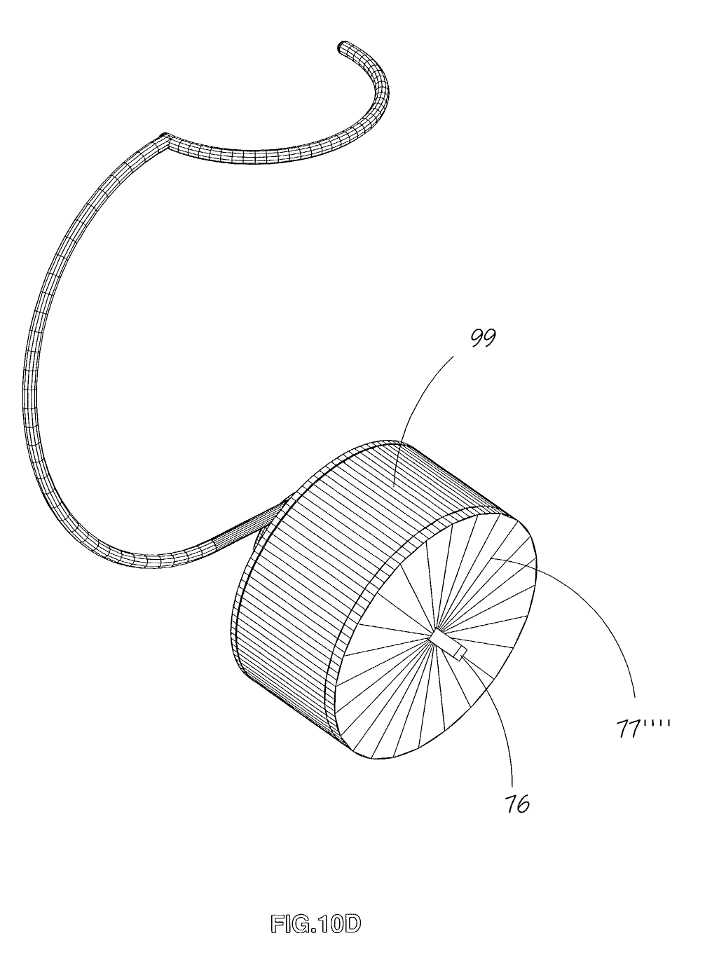

The mechanical braking mechanism utilized in the preferred embodiment may be similar to the one disclosed in allowed U.S. patent application Ser. No. 08/407,079, filed May 20, 1995, and incorporated herein by reference, which discloses a braking mechanism in which a rotating cam is slidable along a rotating axis, the axial position of the cam determining the pressure applied to cam followers, and therefore to the brake shoes. In the preferred embodiment, illustrated in FIGS. 10A-10D, the cam 90 is moved axially by an axially slidable plate 91, with the cam being caused to rotate relative to the plate by axle 76. Cam followers 92 extend through openings in a housing 93 mounted on disc 74 and are biased against cam 90 by springs 94 attached to brake shoes 95.

In order to brake the vehicle using the brakes illustrated in FIGS. 10A-10D, cam 90 is moved axially relative to axle 76 in response to hydraulic actuators 96 connected to hydraulic control lines 97. The surface of cam 90 which is engaged by cam followers 92 has a cross-section that decreases in diameter from the side of the cam on the outside of the wheel to the side of the cam on the inside of the wheel. As a result, as the cam is moved axially toward the outside of the wheel by hydraulic actuators 96, the cam followers 92 are pushed outwardly, causing brake shoes 95 to engage an appropriate lining (i.e., drum 99) on the inside of wheel 4 and thereby brake the vehicle. If desired, the shaped of cam 90 can be varied according to the principles described in allowed U.S. patent application Ser. No. 08/407,079, so that the larger diameter portions of the cam are elliptical in cross-section, which will cause the cam followers move in and out for a given brake pressure as the cam rotates, and thereby provide an anti-lock braking effect.

In the preferred embodiment, the mechanical brakes are actuated by a foot pedal arrangement using pedals 100 positioned under the heel of the rider. Movement of pedals 100 is transmitted by wires 101 or other mechanical linkages to brake cylinders 102, the outputs of which are carried by conduit 103 to an intermediate cylinder 104. Intermediate cylinder 104 includes a branched piston 105 arranged to supply equal amounts of pressure to respective cylinders in housing 106, the output of which is carried by hydraulic lines 97 and 79 to actuators 96. The connection between lines 97 and 79 is shown in FIG. 12 as the terminal for conduits 140. Actuators 96 move the cam 90 and actuators 72, which respectively move the ring 70. Not shown are bias springs to cause return of the brake pedals and cams when the rider releases the brake pressure.

FIG. 11 shows the driver for the second differential illustrated in FIGS. 5D to 5H. The driver uses a simple wire control actuated by pedals 110 located in the vicinity of the main brake pedals 100. Pedals 110 move wires 111 which are combined in mechanism 112 to move a single output wire 113, which passes through a cable to control the second differential described above via actuators 114.

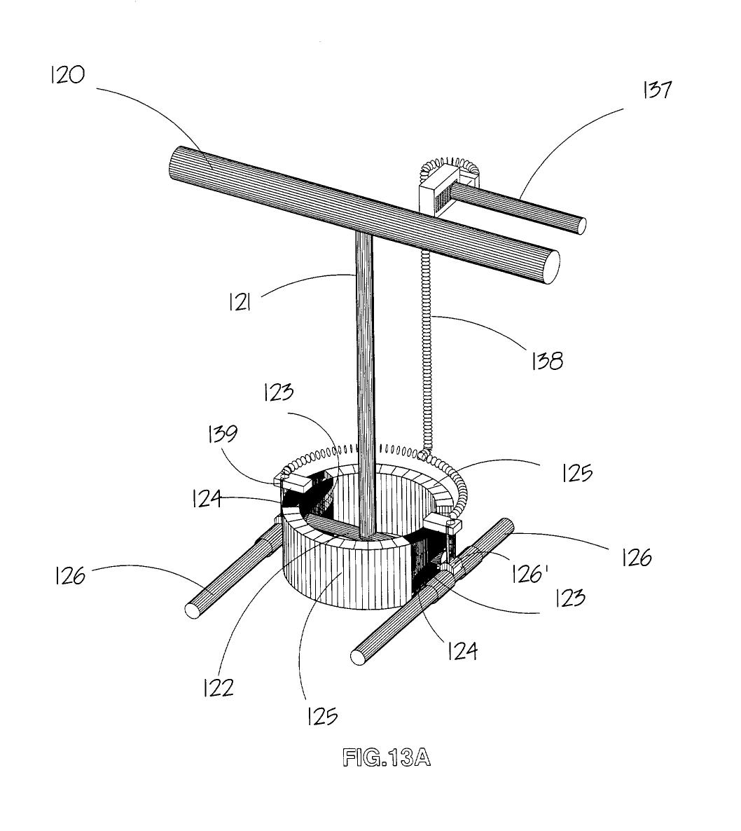

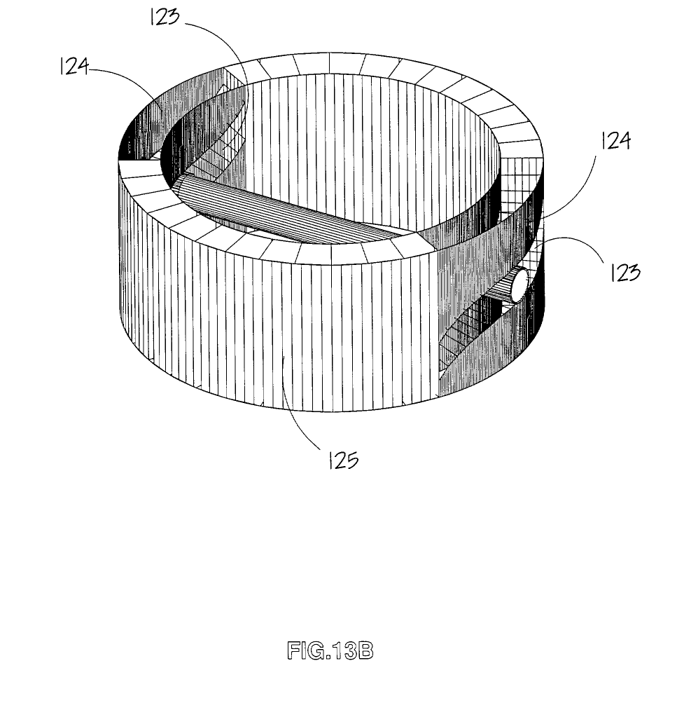

Turning to FIGS. 12, 13A and 13B, steering is accomplished by turning the motorcycle-like handlebar 120, shown in FIG. 13A, which causes a vertical rod 121 and horizontal rod 122 to rotate correspondingly. Rod 122 extends through cam slots 123 in cam plates 124, as illustrated in FIG. 13B, such that rotation of rod 122 causes the rods 120-122 to bend or swing relative to support 126. Frame 127 tilts in response to the relative tilting of rods 121, and causes rotation of a pinion 128. Pinion 128 engages a rack 129 and causes the rack to move linearly in response to tilting of frame 127. Connected to rack 129 is piston shaft 130, which is connected to pistons in each of hydraulic cylinders 131, cylinders 131 in turn being connected to a master cylinder 132 in such a manner that tilting of the frame 127 in one direction causes shaft 133 to extend out of cylinder 132, and tilting of the frame 127 in the other direction causes the shaft to withdraw into the cylinder. Shaft 133 simultaneously moves pistons (not shown) in three different master cylinders 134-136. Cylinder 134 serves as a master cylinder for the electro-magnetic and mechanical braking subsystem, while cylinder 135 serves as a master cylinder for a banking or wheel positioning subsystem, and cylinder 136 serves as a master cylinder for the auxiliary stabilizer subsystem.

Locking and unlocking of the control pod 12 for movement in forward and backward directions is accomplished ugh the use of a mechanism consisting of a lever 137 connected by a wire 138 which controls the pads 126′. Pads 126′ allow movement of the pod along bars 126.

At low speeds, steering may be accomplished solely by braking of the wheels using the electro-magnetic braking mechanism combined with the mechanical anti-lock braking mechanism described in connection with FIGS. 7-10. The connection between the steering and braking mechanisms, and in particular connection points 79 shown in FIG. 12, is provided by lines 140, which are connected to master brake cylinder 134 so that movement of the piston 133 causes a corresponding movement of the left or right coils 70 with respect to magnets 71 in wheels 4, and the corresponding movement of the left or right member 90 with respect to followers 92.

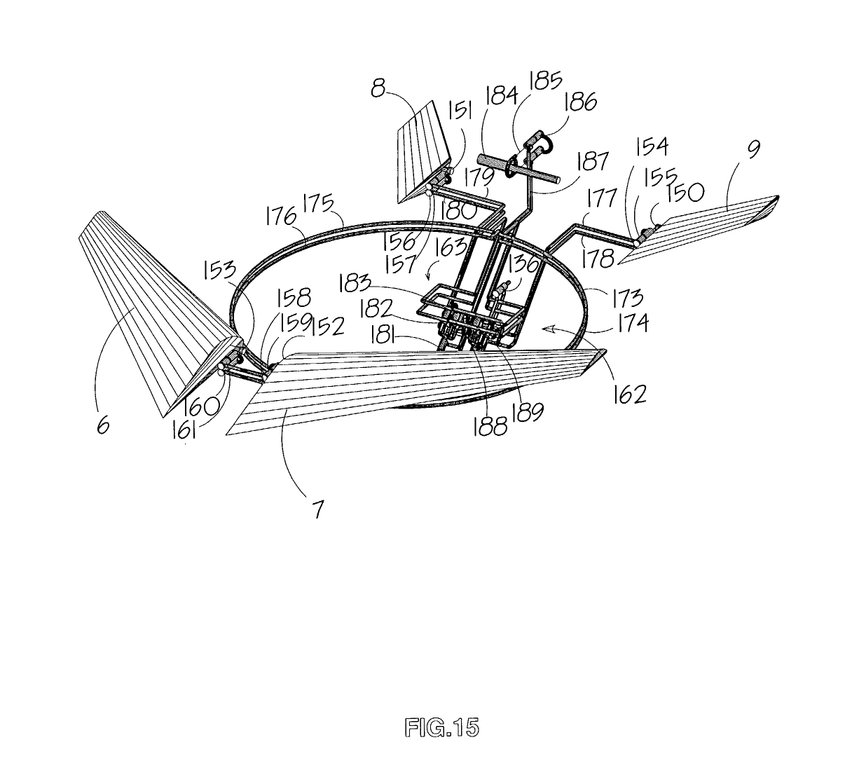

At higher speeds, however, it becomes desirable to bank or tilt the vehicle during a turn, which requires braking of the rotating stabilizing member, and therefore use of the auxiliary stabilizing members to stabilize the vehicle during high speed turns. These functions are accomplished by master cylinder 135, which is connected by lines 14, as described above, to cylinders 23 and struts 22, and by master cylinder 136, which is connected to auxiliary stabilizer control system shown in FIG. 15.

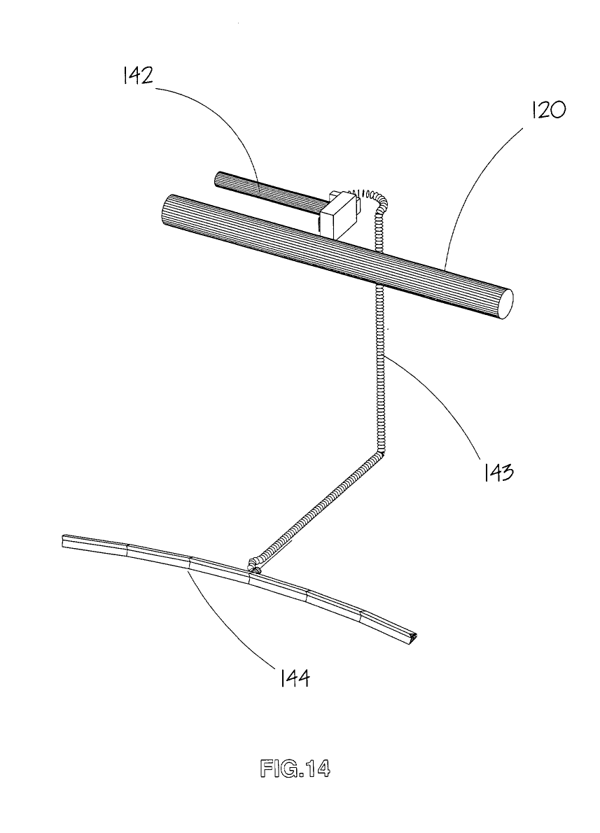

When the handlebars are turned, frame 127 will tilt by an amount sufficient to actuate both the banking and stabilizer control cylinders 135 and 136 in addition to the electromagnetic and mechanical brakes master cylinder and therefore automatic activate the wheel position control and auxiliary stabilization subsystems as described below. It will be appreciated, however, that rotation of the gyroscopic stabilizer 2 will serve to prevent the vertical axis of the vehicle from tilting. As a result, the preferred embodiment includes a subsystem, shown in FIG. 14, for reducing the rotational speed of the stabilizer member 2 when rapid acceleration and high speed maneuvering is desired. The subsystem for braking the gyroscopic stabilizer includes a control lever 142 mounted on handlebar 120, a wire 143, and a brake shoe 144 arranged to press against the rotating stabilizer in order to reduce its rotation and angular momentum.

The auxiliary stabilizers 6-9 are in the form of airfoils, with the front stabilizers 8 and 9 being inverted to pull the front of the vehicle downwards as the rear of the vehicle is lifted by the rear stabilizers 6 and 7. The effect of the stabilizers to counter the tendency of the vehicle to tilt backwards during acceleration, and to facilitate banking during a high speed turn by increasing the lift on the right or left side. Each of the auxiliary stabilizers 6-9 includes, as is best illustrated in FIG. 15, a respective hydraulically operated pivot mechanism 150-153 actuated by pairs of cylinders 154/155-160/161 to pivot about a principal axis of the stabilizers and thereby control the amount of lift generated by the stabilizers. If the stabilizers are pivoted sufficiently, it will be appreciated that the stabilizers can also be used to provide an air braking effect to facilitate rapid deceleration.

Actuation of the respective cylinders 154-161 is accomplished by cylinder assembly 162, shown in FIG. 12,15 and cylinder assembly 163, shown in FIG. 15. Cylinder assembly 162 is part of the steering mechanism and includes master cylinder 136, which is connected to cylinder 164 by hydraulic lines 165. Cylinder 164 includes a piston shaft 168 having four branches to actuating hydraulic fluid in each of four cylinders 169-172, which are connected to cylinder 164 so that stabilizers 6 and 8 may rotate in opposite directions to stabilizers 7 and 9 and thereby provide different amounts of lift on each side of the vehicle in order to facilitate high speed turning of the vehicle in cooperation with the banking effect provided by actuation of struts 22.

The second cylinder assembly 163, on the other hand, simultaneously move stabilizers 6-9 in a direction which increases lift at the rear of the vehicle and a downward force at the front of the vehicle so as to maintain stability during acceleration or deceleration. This is accomplished by connecting master cylinder 181 via a branched piston to cylinders 182,183 and 188,189 and hydraulic lines 173-180 in such a manner that cylinders 182 and 188 commonly actuate the two rear stabilizers, and cylinders 183 and 189 commonly actuates the two front stabilizers. Master cylinder 181 is actuated by a rotatable sleeve 184 on handlebar 120, wires 185 attached to a disc attached to the sleeve, cylinders 186, and hydraulic lines 187 which serve to actuate the piston in master cylinder 181.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention. For example, while the illustrated embodiment utilizes a single rotating stabilizer member, a second stabilizer could be added to a counter-torque and therefore provide additional stabilization. In addition, the gyroscopic stabilizer could be driven by a motor separate from the main propulsion motor, and each of the hydraulic control lines could be replaced by electrical controls, with such features as microprocessor control in order to fine tune the response of the various subsystems to operator control. As indicated above, the vehicle may also be remotely controlled to serve as a toy. Because of the possibility of such variations and modifications of the preferred embodiment of the invention, as well as numerous others which may occur to those skilled in the art, it is intended that the invention not be limited by the above description or accompanying drawings, but that it be defined solely in accordance with the appended claims.

I claim:

1. A gyroscopically stabilized vehicle, comprising:
a frame;
a stabilizer member mounted in said frame;
a motor; and
at least one wheel,
wherein said stabilizer member is arranged to be supported by said frame and driven by said motor to rotate relative to said frame, and
wherein said frame and said stabilizer member are funnel shaped, said wheel being supported by a narrow lower portion of said funnel-shaped frame and said motor being mounted in a wider upper portion of said funnel-shaped frame.

2. A vehicle as claimed in claim 1, further comprising means for supporting a rider seated in the upper wider portion of said frame.

3. A vehicle as claimed in claim 1, wherein said stabilizer member is arranged to be braked by said rider to permit high speed maneuvering of said vehicle.

4. A vehicle as claimed in claim 1, further comprising at least two braking subsystems, one of which includes a brake shoe attached to a cam follower arranged to contact said wheel in response to axial movement of a rotating cam engaged by said cam follower, and the other of which includes an axially movable coil and a magnet attached to said wheel and rotatable around said coil.

5. A vehicle as claimed in claim 1, further comprising a second wheel, said first and second wheels being closely spaced and substantially parallel.

6. A vehicle as claimed in claim 5, wherein each of said wheels includes a brake, and wherein said brakes are separately controllable to steer said vehicle.

7. A vehicle as claimed in claim 6, further comprising individually positionable auxiliary stabilizers for aerodynamically stabilizing said vehicle during high speed maneuvers, and struts arranged to cause said vehicle to tilt during said high speed maneuvers.

8. A vehicle as claimed in claim 7, wherein said auxiliary stabilizers, struts, and brakes are hydraulically actuated by a common master cylinder having a branched piston extending between the common master cylinder and individual master cylinders for the stabilizers, struts, and brakes, whereby said stabilizers, struts, and brakes are commonly controlled to steer said vehicle.

9. A vehicle as claimed in claim 8, wherein said common master cylinder is coupled to left and right cylinders sharing a common piston driven by a rack and pinion mechanism connected to a handlebar positioned in the wider upper part of the frame and arranged to be controlled by a rider seated in the wider upper part of the frame.

10. A vehicle as claimed in claim 9, wherein said handlebar is connected to the rack and pinion mechanism by a cam which is movable to vary the response of the rack and pinion mechanism to turning of the handlebar.

11. A vehicle as claimed in claim 6, wherein said brakes are electro-magnetic brakes, said electromagnetic brakes including magnets mounted to rotate with said wheels, and coils movable into and out of magnetic fields of said magnets, whereby a position of said coils relative to said magnets determines an amount of braking energy transfer between said wheels and said coils.

12. A vehicle as claimed in claim 1, further comprising electro-magnetic brakes, said electromagnetic brakes including magnets mounted to rotate with said wheels, and coils movable into and out of magnetic fields of said magnets, whereby a position of said coils relative to said magnets determines an amount of braking energy transfer between said wheels and said coils.

13. A vehicle as claimed in claim 1, further comprising a differential mechanism positioned in a drive train from said motor to said wheel, said differential mechanism distributing power between said wheel and said stabilizer member.

14. A vehicle as claimed in claim 13, wherein said differential mechanism comprises a first bevel gear arranged to rotate in response to rotation of a motor output shaft, at least one planetary gear engaged with said first bevel gear, and a second bevel gear engaged with said planetary gear, the planetary gear being coupled to the stabilizer member and the second bevel gear being coupled to the wheel, whereby braking of said stabilizer member causes and increase in rotation speed of said second bevel gear to increase a velocity of said vehicle.

15. A vehicle as claimed in claim 1, further comprising a differential mechanism that includes a first bevel gear arranged to rotate in response to rotation of a motor output shaft, at least one planetary gear engaged with said first bevel gear, and a second bevel gear engaged with said planetary gear, the planetary gear being coupled to the stabilizer member and the second bevel gear being coupled to the wheel, whereby braking of said stabilizer member causes and increase in rotation speed of said second bevel gear to increase a velocity of said vehicle.

16. A vehicle as claimed in claim 1, further comprising individually positionable auxiliary stabilizers for aerodynamically stabilizing said vehicle during acceleration and high speed maneuvers.

17. A vehicle as claimed in claim 16, wherein said auxiliary stabilizers include a left rear, left front, right rear, and right front stabilizer, and wherein said left stabilizers and right stabilizers are rotatable in opposite directions to stabilize said vehicle during high speed maneuvering, and said front stabilizers and rear stabilizers are rotatable in opposite directions to stabilize said vehicle during acceleration, and wherein said stabilizers have an airfoil shape, with the rear stabilizers being generally oriented to produce an upward force and the front stabilizers being generally oriented to produce a downward force.

18. A vehicle as claimed in claim 17, wherein said left stabilizers and right stabilizers are commonly coupled to a vehicle steering mechanism, and wherein said rear stabilizers and front stabilizers are directly controlled by an operator of said vehicle.

19. A vehicle as claimed in claim 1, further comprising individually positionable auxiliary stabilizers for aerodynamically stabilizing said vehicle during high speed maneuvers, and struts arranged to cause said vehicle to tilt during said high speed maneuvers.

20. A vehicle as claimed in claim 1, further comprising a mechanical brake including a cam rotatable with an axle of said wheel, a cam follower engaged with said cam, and a brake shoe attached to said cam follower, wherein said cam is arranged to be slid along said axis during rotation of said cam, a shape of said cam determining a pressure applied by said brake shoe on said wheel in response to sliding of said cam along said axis.

21. A gyroscopically stabilized vehicle, comprising:
a frame;
a stabilizer member mounted in said frame;
a motor; and
at least one wheel,
wherein said stabilizer member is arranged to be supported by said frame and driven by said motor to rotate relative to said frame, and
wherein said stabilizer member is arranged to be braked by said rider to permit high speed maneuvering of said vehicle.

22. A gyroscopically stabilized vehicle, comprising:
a frame;
a stabilizer member mounted in said frame;
a motor; and
first and second closely spaced and substantially parallel wheels,
wherein said stabilizer member is arranged to be supported by said frame and driven by said motor to rotate relative to said frame.

23. A vehicle as claimed in claim 22, wherein each of said wheels includes a brake, and wherein said brakes are separately controllable to steer said vehicle.

24. A vehicle as claimed in claim 23, further comprising individually positionable auxiliary stabilizers for aerodynamically stabilizing said vehicle during high speed maneuvers, and struts arranged to cause said vehicle to tilt during said high speed maneuvers.

25. A vehicle as. Claimed in claim 24, wherein said auxiliary stabilizers, struts, and brakes are hydraulically actuated by a common master cylinder having a branched piston extending between the common master cylinder and individual master cylinders for the stabilizers, struts, and brakes, whereby said stabilizers, struts, and brakes are commonly controlled to steer said vehicle.

26. A vehicle as claimed in claim 25, wherein said common master cylinder is coupled to left and right cylinders sharing a common piston driven by a rack and pinion mechanism connected to a handlebar positioned in the frame and arranged to be controlled by a rider seated in the wider upper part of the frame.

27. A vehicle as claimed in claim 26, wherein said handlebar is connected to the rack and pinion mechanism by a cam which is movable to vary the response of the rack and pinion mechanism to turning of the handlebar.

28. A vehicle as claimed in claim 23, wherein said brakes are electromagnetic brakes, said electromagnetic brakes including magnets mounted to rotate with said wheels, and coils movable into and out of magnetic fields of said magnets, whereby a position of said coils relative to said magnets determines an amount of braking energy transfer between said wheels and said coils.

29. A vehicle as claimed in claim 22, further comprising individually positionable auxiliary stabilizers for aerodynamically stabilizing said vehicle during acceleration and high speed maneuvers.

30. A vehicle as claimed in claim 29, wherein said auxiliary stabilizers include a left rear, left front, right rear, and right front stabilizer, and wherein said left stabilizers and right stabilizers are rotatable in opposite directions to stabilize said vehicle during high speed maneuvering, and said front stabilizers and rear stabilizers are rotatable in opposite directions to stabilize said vehicle during acceleration, and wherein said stabilizers have an airfoil shape, with the rear stabilizers being generally oriented to produce an upward force and the front stabilizers being generally oriented to produce a downward force.

31. A vehicle as claimed in claim 30, wherein said left stabilizers and right stabilizers are commonly coupled to a vehicle steering mechanism, and wherein said rear stabilizers and front stabilizers are directly controlled by an operator of said vehicle.

32. A vehicle as claimed in claim 22, further comprising individually positionable auxiliary stabilizers for aerodynamically stabilizing said vehicle during high speed maneuvers, and struts arranged to cause said vehicle to tilt during said high speed maneuvers.

33. A vehicle as claimed in claim 22, further comprising a mechanical brake including a cam rotatable with an axle of said wheel, a cam follower engaged with said cam, and a brake shoe attached to said cam follower, wherein said cam is arranged to be slid along said axis during rotation of said cam, a shape of said cam determining a pressure applied by said brake shoe on said wheel in response to sliding of said cam along said axis.

35. A gyroscopically stabilized vehicle, comprising:
a frame;
a stabilizer member mounted in said frame;
a motor; and
and at least one wheel,
wherein said stabilizer member is arranged to be supported by said frame and driven by said motor to rotate relative to said frame, and
further comprising a differential mechanism positioned in a drive train from said motor to said wheel, said differential mechanism distributing power between said wheel and said stabilizer member.

36. A vehicle as claimed in claim 35, wherein said differential mechanism comprises a first bevel gear arranged to rotate in response to rotation of a motor output shaft, at least one planetary gear engaged with said first bevel gear, and a second bevel gear engaged with said planetary gear, the planetary gear being coupled to the stabilizer member and the second bevel gear being coupled to the wheel, whereby braking of said stabilizer member causes and increase in rotation speed of said second bevel gear to increase a velocity of said vehicle.
